(19) United States
(12) Patent Application Publication
(10) Pub. No.: US 2016/0247077 A1
(43) Pub. Date: Aug. 25, 2016

(54) SYSTEM AND METHOD FOR PROCESSING RAW DATA

(71) Applicant: HCL Technologies Limited, Noida (IN)

(72) Inventors: Bibhore SINGHAL, Noida (IN); Yogesh GUPTA, Noida (IN)

(21) Appl. No.: 15/005,117

(22) Filed: Jan. 25, 2016

(30) Foreign Application Priority Data
Feb. 19, 2015 (IN) 476/DEL/2015

(51) Int. Cl. G06N 5/04

(52) U.S. Cl. CPC G06N 5/047

(57) ABSTRACT

System and method for processing a raw data is disclosed. The system is configured to identifying a pattern using a plurality of datasets selected from the raw data. Further, the system is configured to fetching a first set of data patterns associated with a first set of historical visualizations. The system further identifies a second set of data patterns from the first set of data patterns by matching the pattern with the first set of data patterns. Furthermore, the system is configured to identify a second set of historical visualizations associated with the second set of data patterns from the first set of historical visualizations. Further, the system is configured to represent the raw data graphically for predictive analysis based on at least one historical visualization selected from the second set of historical visualizations.

### CROSS-REFERENCE TO RELATED APPLICATIONS AND PRIORITY

The present application claims benefit from Indian Patent Application No. 476/DEL/2015, filed on Feb. 19, 2015, the entirety of which is hereby incorporated by reference.

### TECHNICAL FIELD

The present disclosure in general relates to the field data processing. More particularly, the present disclosure relates to a system and method for visually representing raw data for predictive analysis.

### BACKGROUND

Data Visualization and predictive data analysis is a technique for predicting and visualizing raw data into meaningful business visualizations for giving a deeper insight into what the raw data is or how to make best use of the data for different business purposes. There are many software applications in the art that provide data mining capabilities combined with rich data elements like charts and dashboards. The process of data mining involves extracting information from a data set and transforming the data sets into an understandable structure by discovering different patterns using methods like artificial intelligence, machine learning and database systems. The process of data mining requires predefined rules and knowledge patterns which necessitate manual intervention in the overall process of data mining. The user expertise and data mining skills play a vital role in the overall process of data mining. Furthermore, the data mining tools available in the art perform analysis based on the existing data and its deviation over a period of time which restricts the knowledge patterns under the influence of the existing raw data.

Further, once the data mining phase is completed, a typical Decision Support System (DSS) or analysis tool outputs raw data which is of not much significance to the business user for building any visualization or meaningful visual predictions without having expert analytical skills. Moreover, charts and dashboards need to be created manually by selecting the type of chart and querying the raw data required to plot on it.

### SUMMARY

This summary is provided to introduce aspects related to systems and methods for processing raw data and the aspects are further described below in the detailed description.

In one implementation, a method for processing a raw data is disclosed. Initially, a pattern is identified by a processor from the raw data, wherein the patterns is identified using a plurality of datasets selected from the raw data. In the next step, a first set of data patterns associated with a first set of historical visualizations are fetched from an online repository by the processor. Further, a second set of data patterns applicable to the plurality of datasets is identified by the processor, by matching the pattern with the first set of data patterns, wherein the second set of data patterns is a sub set of the first set of data patterns. In the next step, a second set of historical visualizations associated with the second set of data patterns is identified from the first set of historical visualizations by the processor. Further, the raw data is represented graphically by the processor for predictive analysis based on at least one historical visualization, wherein the at least one historical visualization is selected from the second set of historical visualizations.

In one implementation, a system for processing a raw data is disclosed. The system includes a memory and a processor coupled to the memory, wherein the processor is configured to identifying a pattern using a plurality of datasets selected from the raw data. Further, the processor is configured to fetching a first set of data patterns associated with a first set of historical visualizations. The processor further identifies a second set of data patterns applicable to the plurality of datasets by matching the pattern with the first set of data patterns, wherein the second set of data patterns is a sub set of the first set of data patterns. Furthermore, the processor is configured to identify a second set of historical visualizations associated with the second set of data patterns from the first set of historical visualizations. Further, the processor is configured to represent the raw data graphically for predictive analysis based on at least one historical visualization, wherein the historical visualization is selected from the second set of historical visualizations.

In one implementation, a computer program product having embodied thereon a computer program for processing a raw data is disclosed. The computer program includes a program code for identifying a pattern using a plurality of datasets selected from the raw data. The computer program includes a program code for fetching a first set of data patterns associated with a first set of historical visualizations. The computer program further includes a program code for identifying a second set of data patterns applicable to the plurality of datasets by matching the pattern with the first set of data patterns, wherein the second set of data patterns is a sub set of the first set of data patterns. The computer program further includes a program code for identifying a second set of historical visualizations associated with the second set of data patterns from the first set of historical visualizations. The computer program further includes a program code for representing the raw data graphically for predictive analysis based on at least one historical visualization selected from the second set of historical visualizations.

### BRIEF DESCRIPTION OF DRAWINGS

The detailed description is described with reference to the accompanying Figures. In the Figures, the left-most digit(s) of a reference number identifies the Figure in which the reference number first appears. The same numbers are used throughout the drawings to refer like/similar features and components.

FIG. 1 illustrates a network implementation of a system for processing a raw data, in accordance with an embodiment of the present disclosure.

FIG. 2 illustrates the system for processing the raw data, in accordance with an embodiment of the present disclosure.

FIG. 3 illustrates different components of the system for processing the raw data, in accordance with an embodiment of the present disclosure.

FIG. 4 illustrates a process for extracting patterns from the raw data, in accordance with an embodiment of the present disclosure.

FIG. 5 illustrates a process for extracting a first set of data patterns from a historical pattern store, in accordance with an embodiment of the present disclosure.

FIG. 6 illustrates a process for extracting a second set of data patterns from the first set of data patterns, in accordance with an embodiment of the present disclosure.

FIG. 7 illustrates a flowchart representing a method for processing the raw data, in accordance with an embodiment of the present disclosure.

### DETAILED DESCRIPTION

The present invention will now be described more fully hereinafter with reference to the accompanying drawings and diagrams in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings. The present disclosure relates to systems and methods for processing raw data. In one implementation, the system is configured to analyze a plurality of datasets selected from the raw data to identify at least one pattern associated with the raw data. Further, the system is configured to match the pattern with a first set of data patterns associated with a first set of historical visualization to identify a historical visualization applicable to the pattern. Further, the system is configured to represent the raw data graphically using the historical visualization identified from the first set of historical visualization.

While aspects of the described system and method for processing the raw data may be implemented in any number of different computing systems, environments, and/or configurations, the embodiments are described in the context of the following exemplary system.

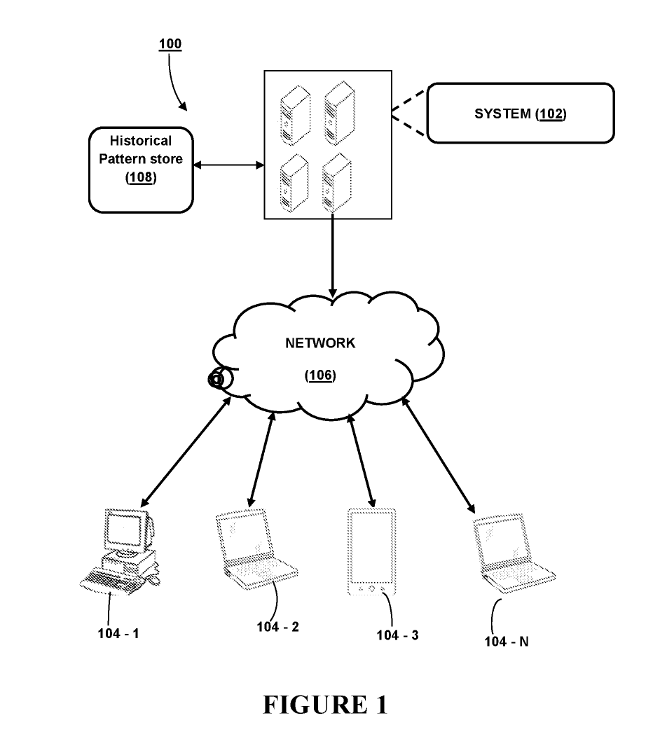

Referring to FIG. 1, a network implementation 100 of the data processing system, hereafter referred to as a system 102 for processing the raw data is illustrated, in accordance with an embodiment of the present disclosure. Although the present disclosure is explained by considering that the system 102 is implemented as a software program on a server, it may be understood that the system 102 may also be implemented in a variety of computing systems, such as a laptop computer, a desktop computer, a notebook, a workstation, a mainframe computer, a server, a network server, cloud, and the like. It will be understood that the system 102 may be accessed by multiple users through one or more user devices 104-1, 104-2, 104-3, 104-N, collectively referred to as user devices 104 hereinafter, or applications residing on the user devices 104. Examples of the user devices 104 may include, but are not limited to, a portable computer, a personal digital assistant, a hand-held device, and a workstation. The user devices 104 are communicatively coupled to the system 102 through a network 106. Further, the system 102 is also connected to a historical pattern store 108. The historical pattern store 108 is configured to store the first set of historical visualizations. In one embodiment, the first set of data patterns corresponding to the first set of historical visualizations are also maintained in the historical pattern store 108. The first set of data patterns may include patterns gathered from online sources, patterns generated by self analysis and patterns generated by accepting user inputs. In one embodiment, the first set of data patterns is indicative of features associated with historically analyzed data, wherein these features include a skewed right, a skewed left, a uniform distribution, bell-shaped curves, and Number of peaks.

In one implementation, the network 106 may be a wireless network, a wired network or a combination thereof The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

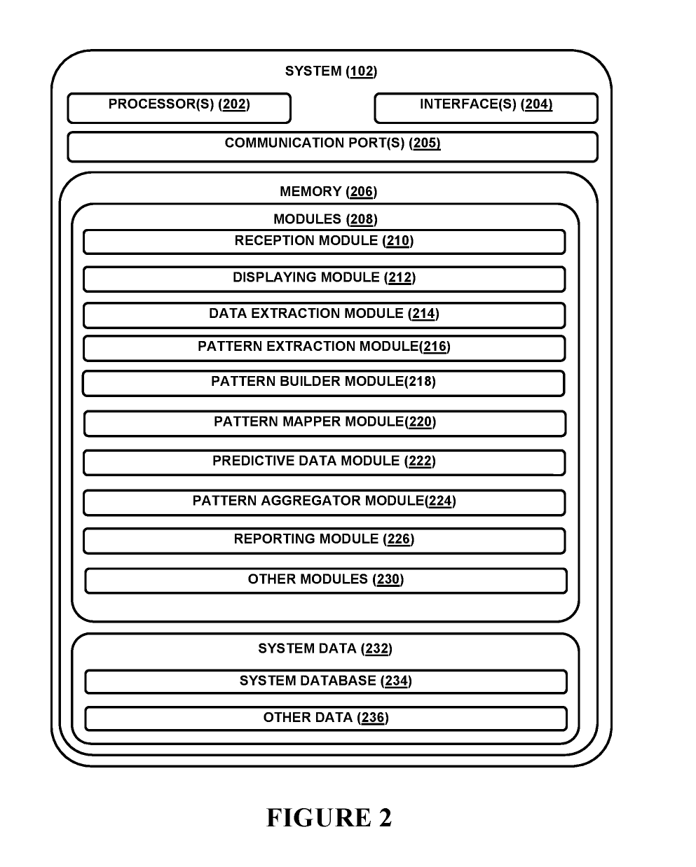

Referring now to FIG. 2, the system 102 is illustrated in accordance with an embodiment of the present disclosure. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the user devices 104. Further, the I/O interface 204 may enable the system 102 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and system data 230.

The modules 208 include routines, programs, objects, components, data structures, etc., which perform particular tasks or implement particular abstract data types. In one implementation, the modules 208 may include a reception module 210, a displaying module 212, a data extraction module 214, a pattern extraction module 216, a pattern builder module 218, a Pattern mapper module 220, a predictive data module 222, a pattern aggregator module 224, a reporting module 226, and other modules 230. The other modules 230 may include programs or coded instructions that supplement applications and functions of the system 102.

The system data 232, amongst other things, serves as a repository for storing data processed, received, and generated by one or more of the modules 208. The system data 232 may also include a system database 234 and other data 236. The other data 236 may include data generated as a result of the execution of one or more modules in the other modules 230.

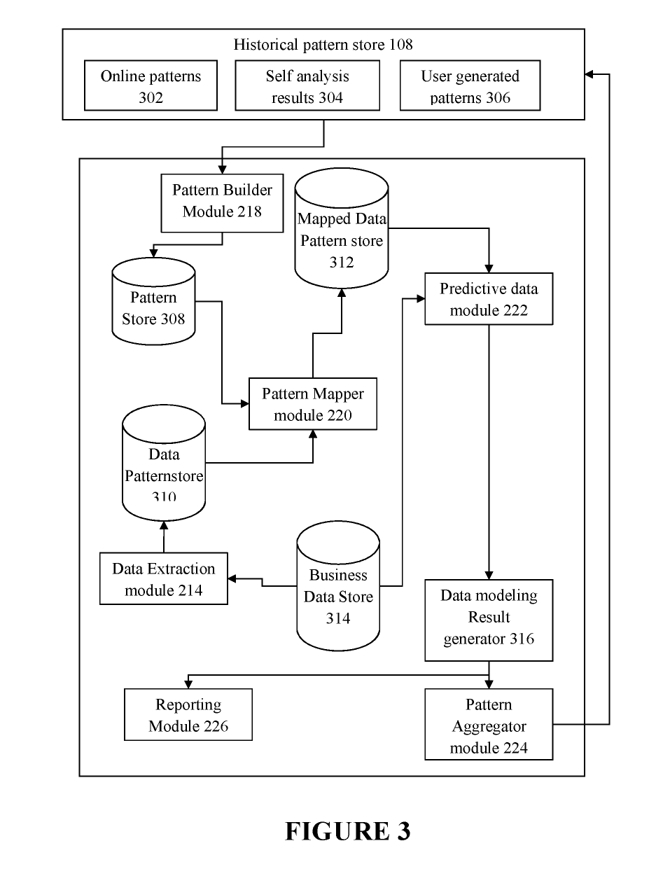

In one implementation, the multiple users may use the client devices 104 to access the system 102 via the I/O interface 204. In one embodiment, the system 102 may employ the reception module 210 to receive instructions for processing the raw data from user devices 104. In one embodiment the user devices 104 may be a data warehousing platform for collecting and storing the raw data. The processing of the raw data by the system 102 is further explained with respect to the block diagram of FIG. 3.

FIG. 3 represents a detailed outline of the modules 208 of the system 102 involved in processing the raw data for the purpose of predictive data visualization. Initially, the data extraction module 214 of the system 102 extracts at least one pattern from raw data, wherein the raw data is stored in a business data store 314. In order to extract patterns from the raw data, the data extraction module 214 samples the raw data at predefined intervals based on a set of values associated with the raw data to generate the plurality of datasets. The set of values may be selected from the number of attributes, the number of records, maximum and minimum values associated with each attribute in the raw data. Further, the pattern from the raw data is identified by performing keyword based analysis over the plurality of datasets and is stored in the data pattern store 310.

In the next step, the pattern extraction module 216 fetches a first set of data patterns from the historical pattern store 108. The first set of data patterns is a collection of online patterns 302, self-analysis results 304 and user generated patterns 306. In the next step, the pattern builder module 218 analyzes the first set of data patterns and builds a mapping between the patterns extracted from the data pattern store 310 and the first set of data patterns, by indexing the most recent and recommended pattern results first. The pattern data is fetched on the basis of knowledge gathered from the patterns, the first set of data patterns are then combined with the patterns and stored in a pattern store 308. These patterns are combined with first set of data patterns based on generic characteristics measurable in terms of relationships like time, business domain, quantity etc.

In the next step, the pattern mapper module 220 matches the first set of data patterns from the pattern store 308 and the pattern from the data pattern store 310, to identify a second set of data patterns, wherein the second set of data patterns are a set of best fit patterns for processing the raw data. In one embodiment, the second set of data patterns is stored in a mapped data pattern store 312.

Further, the predictive data module 222 utilizes the second set of data patterns from the mapped data pattern store 312 and the business scenario associated with the raw data to ranking the second set of data patterns. In one embodiment, there can be multiple predictions associated with the raw data for multiple business scenarios. The predictive data module 222 generates multiple predictors which point to a particular area of raw data. Further, the predictive data module 222 is configured to identify a second set of historical visualizations from the first set of historical visualizations based on the second set of data patterns and transmit them to the data modelling result generator 316.

Data modelling result generator 316 represents a mapping between the pattern associated with the raw data and the second set of data patterns. In one embodiment, the mapping contains the following information:
Data portion (Best fit model type)
Significant age
Best fit data field
Data sector id (business case type)
Rank
Linked external model for reference

Further, the pattern aggregator module 224 updates the higher ranked patterns to the historical pattern store 108. In one embodiment, only the pattern metadata is updated without any business data or user information. The pattern aggregator module 224 updates the historical pattern store 108 on demand and on scheduled basis.

In the next step, the reporting module 226 provides the data visualization and dashboard solution for the business predictions specified by the user. Based on the requirements specified by the user, the reporting module 226 selects at least one visualization from the second set of visualizations and builds the required charts and dashboards to graphically represent the pattern identified from the raw data. The user also has the option to change the selected visualization charts like selecting a pie chart in place of automatically selected bar chart using the I/O interface 204.

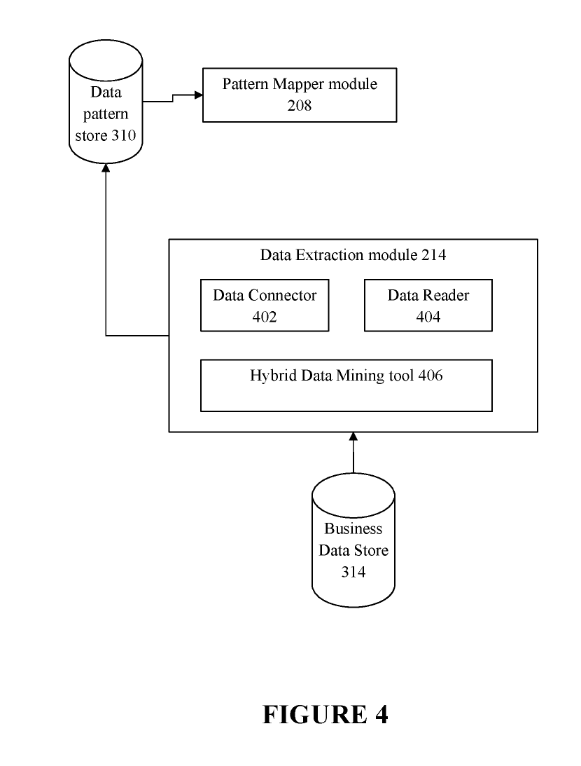

Further, the process for extracting patterns from the raw data by the data extraction module 214 is illustrated in FIG. 4. The data extraction module 214 uses the data connector 402 for connecting with the data pattern store 310 and business data store 314. The data connector 402 connects directly or through the network 106 to the data pattern store 310 and the business data store 314 if the stores are located at some remote location for performance reasons. Further, the data extraction module 214 enables a data reader 404, wherein the data reader 404 is configured to read formatted patterns from the raw data using pattern mapping and mining techniques. Further, the hybrid data mining tool 406 is configured to extract the useful patterns and predicates from the raw data stored in the business data store 314 and stores the useful patterns and predicates in the data pattern store 310. For this purpose, the hybrid data mining tool 406 takes random data samples from raw data at any given period of time or volume and checks whether the samples contain some information that is useful in generating the required visualizations and patterns. If the data extraction module 214 is unable to find any useful sample, data extraction module 214 utilizes conventional data mining techniques involving user inputs, queries and data extraction until it finds at least one useful pattern. Once the pattern is identified, it is stored in the data pattern store 310.

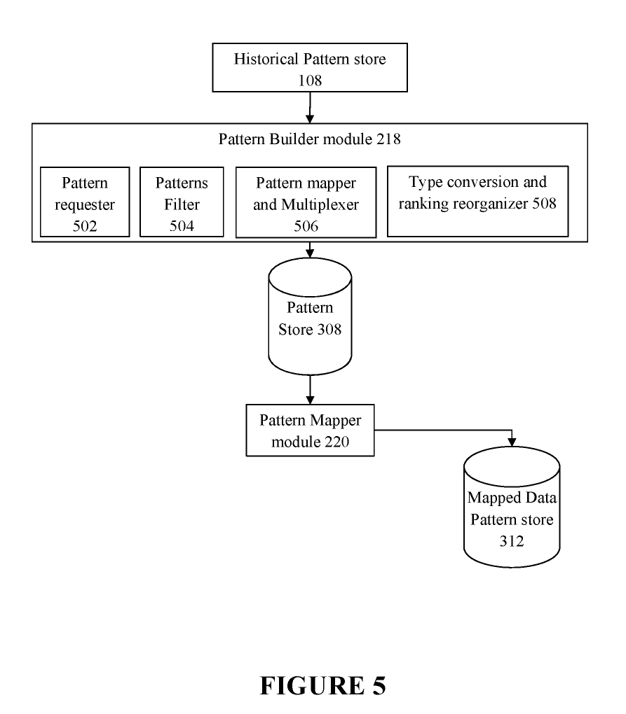

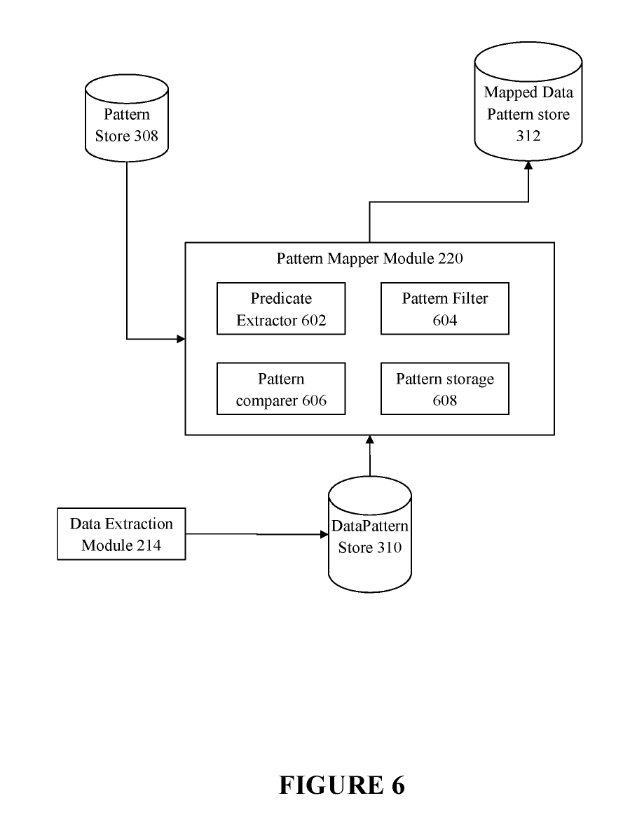

FIG. 5 depicts a process for extracting a first set of data patterns from a historical pattern store, by the pattern builder module 218. The pattern builder module 218 connects to the different pattern sources from the historical pattern store 108 and builds a mapping by indexing the most recent and recommended pattern results first. The pattern builder module 218 enables a pattern requester 502 which requests first set of data patterns from the historical pattern store 108. The pattern builder module 218 further comprises of a pattern filter 504, which filters out any irrelevant patterns from the first set of data patterns with very low ranking. Further, the pattern mapper and multiplexer component 506 maps and multiplex any external pattern results with the extracted patterns from business data store 314 to rank the results for data division into useful categories. The pattern mapper and multiplexer component 506 acts as a bridge between the patterns associated with the raw data and first set of patterns by one to one mapping and filtering based on measurable characteristics. The pattern mapper and multiplexer component 506 is enabled to consume the two set of patterns as input and produces a combined result as output. Further, the first set of data patterns are converted to business specific/geography specific type like changes in period calculation, area calculation etc. by the type conversion and ranking reorganizer 508. The type conversion and ranking reorganizer 508 reorganizes the multiplexed output from the pattern mapper and multiplexer component 506 into meaningful categories in terms of business parameters like stock, marketing etc. Further, the type conversion and ranking reorganizer 508 decides whether to ignore the patterns which may not be directly organized in categories or place them into most recent cat gory. The organization of patterns also has an effect on their ranking as every category has different ranking based on usability. Further, the first set of data patterns is stored in the pattern store 308, which is then processed by the pattern mapper module 220 for recognizing the second set of data patterns that are applicable to the raw data. The processing steps performed by the pattern mapper module 220 are further explained with respect to the block diagram of FIG. 6.

Further, FIG. 6 illustrates a process for extracting the second set of data patterns from the first set of data patterns by the pattern mapper module 220. The pattern mapper module 220 maps the first set of data patterns with the pattern associated with the raw data to identify a second set data patterns that best fit for the business scenario associated with the raw data. Further, the pattern mapper module 220 also ranks the patterns from the second set of data patterns based on at least one of historical recommendations or geographical location of the users. The second set of data patterns is stored in the mapped data pattern store 312. Further, the pattern mapper module 220 consists of predicate extractors 602 to extract predicates from the pattern extracted from the raw data. The predicates represent useful information associated with the raw data at any point of time. These predicates are compared against the available business data pattern to identify the significant data portions and business case. Further, a pattern comparer 604 matches the first set of data patterns from the pattern store 308 with the pattern associated with the raw data to identify the second set of data patterns. In the next step, the pattern filter 606 is configured to filters out any non-relevant patterns from the second set of data patterns. Further, the pattern storage 608 is responsible for temporary storage of the second set of data patterns in mapped data pattern store 312.

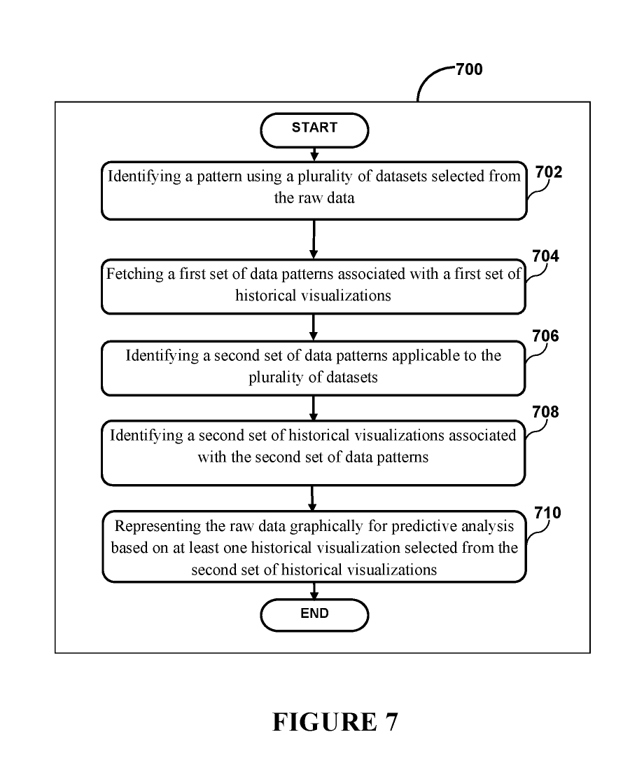

Once the second set of data patterns are stored in the mapped data pattern store 312, the predictive data module 222 utilizes the second set of data patterns from the mapped data pattern store 312 and the business scenario associated with the raw data to ranking the second set of data patterns. Once the second set of data patterns are ranked, the predictive data module 222 is further configured to identify a second set of historical visualizations from the first set of historical visualizations based on the second set of data patterns. Further, the reporting module 226 selects at least one visualization from the second set of visualizations and builds the required charts and dashboards to graphically represent the pattern identified from the raw data. The detailed method for processing the raw data for predictive analysis is disclosed with respect to the flowchart of FIG. 7

FIG. 7 discloses a flowchart 700 for processing the raw data by the system 102. At step 702, the data extraction module 214 of the system 102 analyzes the raw data to identify at least one pattern using a plurality of datasets selected from the raw data, wherein the raw data is stored in a business data store 314. In order to extract patterns from the raw data, the data extraction module 214 samples the raw data at predefined intervals based on a set of values associated with the raw data to generate the plurality of datasets. The set of values may be selected from the number of attributes, the number of records, maximum and minimum values associated with each attribute in the raw data. Further, the patterns are identified by performing keyword based analysis over the plurality of datasets and stored in the data pattern store 310.

Further, at step 704, the first set of data patterns associated with a first set of historical visualizations are fetched from the historical pattern store 108 by the pattern builder module 218. The first set of data patterns consists of online patterns 302, self-analysis results 304 and patterns generated by user 306.

At step 706, the second set of data patterns applicable to the plurality of datasets is identified by matching the pattern with the first set of data patterns. In one embodiment, the second set of data patterns are ranked based on the business scenario associated with the raw data and are stored in a mapped data pattern store 312.

At step 708, the predictive data module 222 utilizes the second set of data patterns from the mapped data pattern store 312 and the pattern extracted from the raw data for predicting the best fit pattern and knowledge for a particular business scenario, wherein the business scenario is identified from the raw data. In one embodiment, there can be multiple predictions for the multiple business scenarios. The predictive data module 222 generates multiple predictors which point to a particular area of raw data and identifies a second set of historical visualizations, wherein the second set of historical visualizations is a collection graphical representation associated with the second set of data patterns.

At step 710, based on the second set of historical visualizations, the reporting module 226 selects at least one visualization from the second set of visualization and builds the required charts and dashboards for predictive analysis of the raw data.

Although the present disclosure relates to implementation of system and method for processing of raw data, it is to be understood that the appended claims are not necessarily limited to the specific features or methods described herein. However, the specific features and methods are disclosed as examples of implementations for processing and visually representing the raw data.

We claim:

1. A system for processing a raw data, the system comprising:
a memory; and
a processor coupled to the memory, wherein the processor is configured to perform the steps of:
identifying a pattern using a plurality of datasets selected from the raw data;
fetching a first set of data patterns associated with a first set of historical visualizations;
identifying a second set of data patterns applicable to the plurality of datasets by matching the pattern with the first set of data patterns, wherein the second set of data patterns is a sub set of the first set of data patterns;
identifying a second set of historical visualizations associated with the second set of data patterns from the first set of historical visualizations; and
representing the raw data graphically for predictive analysis based on at least one historical visualization selected from the second set of historical visualizations.

2. The system of claim 1, wherein the plurality of datasets are generated by sampling the raw data at predefined intervals based on a set of values associated with the raw data.

3. The system of claim 1, wherein the pattern is identified by performing keyword based analysis over the plurality of datasets.

4. The system of claim 1, wherein the first set of data patterns and the first set of historical visualizations are stored in an online repository.

5. The system of claim 1, further comprising selecting at least one historical visualization from the second set of historical visualizations.

6. The system of claim 1, further comprising categorizing and ranking the historical visualizations present in the second set of historical visualizations based on at least one of historical recommendations or geographical location of the users.

7. The system of claim 1, wherein the first set of historical visualizations is a set of graphs used to represent raw data.

8. The system of claim 1, wherein the first set of data patterns is indicative of features associated with historically analyzed data, wherein these features associated with the historically analyzed data include at least one of a skewed right, a skewed left, a uniform distribution, bell-shaped curves, and number of peaks.

9. A method for processing a raw data, the method comprising steps of:
identifying, by a processor, a pattern using a plurality of datasets selected from the raw data;
fetching, by the processor, a first set of data patterns associated with a first set of historical visualizations;
identifying, by the processor, a second set of data patterns applicable to the plurality of datasets by matching the pattern with the first set of data patterns, wherein the second set of data patterns is a sub set of the first set of data patterns;
identifying, by the processor, a second set of historical visualizations associated with the second set of data patterns from the first set of historical visualizations; and
representing, by the processor, the raw data graphically for predictive analysis based on at least one historical visualization selected from the second set of historical visualizations.

10. The method of claim 9, wherein the plurality of datasets are generated by sampling the raw data at predefined intervals based on a set of values associated with the raw data.

11. The method of claim 9, wherein the pattern is identified by performing keyword based analysis over the plurality of datasets.

12. The method of claim 9, wherein the first set of data patterns and the first set of historical visualizations are stored in an online repository.

13. The method of claim 9, further comprising selecting at least one historical visualization from the second set of historical visualizations.

14. The method of claim 9, further comprising categorizing and ranking the historical visualizations present in the second set of historical visualizations based on at least one of historical recommendations or geographical location of the users.

15. The method of claim 9, wherein the first set of historical visualizations is a set of graphs used to represent raw data.

16. The method of claim 9, wherein the first set of data patterns is indicative of features associated with historically analyzed data, wherein these features associated with the historically analyzed data include at least one of a skewed right, a skewed left, a uniform distribution, bell-shaped curves, and number of peaks.

17. A computer program product having embodied thereon a computer program for processing a raw data, the computer program product comprising:
a program code for identifying a pattern using a plurality of datasets selected from the raw data;
a program code for fetching a first set of data patterns associated with a first set of historical visualizations;
a program code for identifying a second set of data patterns applicable to the plurality of datasets by matching the pattern with the first set of data patterns, wherein the second set of data patterns is a sub set of the first set of data patterns;
a program code for identifying a second set of historical visualizations associated with the second set of data patterns from the first set of historical visualizations; and
a program code for representing the raw data graphically for predictive analysis based on at least one historical visualization selected from the second set of historical visualizations.
